(19) United States
(12) Patent Application Publication
(10) Pub. No.: US 2019/0070551 A1
(43) Pub. Date: Mar. 7, 2019

(54) Combined Direct Contact Exchanger and Indirect-Contact Heat Exchanger

(71) Applicants: Larry Baxter, Orem, UT (US); Hannah Knight, Provo, UT (US); Blake Pilling, Provo, UT (US); Nathan Davis, Bountiful, UT (US)

(72) Inventors: Larry Baxter, Orem, UT (US); Hannah Knight, Provo, UT (US); Blake Pilling, Provo, UT (US); Nathan Davis, Bountiful, UT (US)

(21) Appl. No.: 15/696,411

(22) Filed: Sep. 6, 2017

(51) Int. Cl. B01D 53/00; F25J 3/08; B01D 53/14; B01D 53/18

(52) U.S. Cl. CPC B01D 53/002; F25J 3/08; B01D 53/1475; B01D 53/18; B01D 2252/102; F25J 2205/30; B01D 2252/103; B01D 2252/205; F25J 2205/32

(57) ABSTRACT

A device and a method for separating a vapor component from a gas is disclosed. A vessel comprising a top portion and a bottom portion is provided. The top portion comprises a gas outlet, a fluid inlet, and a direct-contact heat exchanger. The bottom portion comprises an indirect-contact heat exchanger, a gas inlet manifold, and a fluid outlet manifold. The indirect-contact heat exchanger is aligned vertically and comprises parallel exchange surfaces. Plenums between the exchange surfaces comprise alternating, adjacent ascending gas channels and descending fluid channels. The gas inlet manifold comprises one or more inlets adjacent to a top portion of each of the ascending gas channels. The fluid outlet manifold comprises one or more outlets adjacent to a bottom portion of each of the descending fluid channels.

This invention was made with government support under DE-FE0028697 awarded by The Department of Energy. The government has certain rights in the invention.

### FIELD OF THE INVENTION

This invention relates generally to separation of vapors from gases. More particularly, we are interested in removal of acid gases, such as carbon dioxide, from gas stream, such as flue gas.

### BACKGROUND

Direct-contact exchange (DCE), both heat and material, is a process that is used extensively in a broad spectrum of industries for an even broader range of applications. Removal of vapors from gases is one of these applications. DCE is most often conducted in spray towers and bubble towers, along with variations on these.

Indirect-contact heat exchangers (ICHE) may be used for gas-vapor separations by desublimation of the vapor onto the surface of the exchanger as a solid, followed by solids removal. This process suffers from limitations including batchwise processing, limited surface area, and fouling. However, ICHE, when used for simple heat exchange between fluids, benefits from the lack of mixing of fluids that DCE suffers, which allows for flexibility in fluid handling and removes vapor-liquid separation steps.

A gas-vapor separating device that combines the benefits of ICHE and DCE while minimizing and eliminating the difficulties of each is needed.

U.S. Pat. No. 965,116, to Morison teaches a cooling tower. The present disclosure differs from this disclosure in that the disclosure only utilizes DCE, and does not have a joint DCE/ICHE unit. This disclosure is pertinent and may benefit from the devices disclosed herein and is hereby incorporated for reference in its entirety for all that it teaches.

U.S. Pat. No. 2,568,875, to Hartmann teaches a spray-type absorption tower. The present disclosure differs from this disclosure in that the disclosure only utilizes DCE, and does not have a joint DCE/ICHE unit. This disclosure is pertinent and may benefit from the devices disclosed herein and is hereby incorporated for reference in its entirety for all that it teaches.

U.S. Pat. No. 5,545,356, to Curtis, et al., teaches an industrial cooling tower. The present disclosure differs from this disclosure in that the disclosure only utilizes DCE, and does not have a joint DCE/ICHE unit. This disclosure is pertinent and may benefit from the devices disclosed herein and is hereby incorporated for reference in its entirety for all that it teaches.

U.S. Pat. No. 2,292,350, to Brandt, teaches a heat exchange apparatus. The present disclosure differs from this disclosure in that the disclosure only utilizes DCE, and does not have a joint DCE/ICHE unit. This disclosure is pertinent and may benefit from the devices disclosed herein and is hereby incorporated for reference in its entirety for all that it teaches.

U.S. Pat. No. 2,833,527, to Kohl, et al., teaches an industrial cooling tower. The present disclosure differs from this disclosure in that the disclosure only utilizes DCE, and does not have a joint DCE/ICHE unit. This disclosure is pertinent and may benefit from the devices disclosed herein and is hereby incorporated for reference in its entirety for all that it teaches.

U.S. Pat. No. 5,942,164, to Tran, teaches a combined heat and mass transfer device for improving a separation process. The present disclosure differs from this disclosure in that the disclosure only utilizes DCE, and does not have a joint DCE/ICHE unit. This disclosure is pertinent and may benefit from the devices disclosed herein and is hereby incorporated for reference in its entirety for all that it teaches.

### SUMMARY

A method for separating a vapor component from a gas is disclosed. A vessel comprising a top portion and a bottom portion is provided. The top portion comprises a gas outlet, a fluid inlet, and a direct-contact heat exchanger. The bottom portion comprises an indirect-contact heat exchanger, a gas inlet manifold, and a fluid outlet manifold. The indirect-contact heat exchanger is aligned vertically and comprises parallel exchange surfaces. Plenums between the exchange surfaces comprise alternating, adjacent ascending gas channels and descending fluid channels. The gas inlet manifold comprises one or more inlets adjacent to a top portion of each of the ascending gas channels. The fluid outlet manifold comprises one or more outlets adjacent to a bottom portion of each of the descending fluid channels.

In some embodiments, a fluid passes through the fluid inlet, the fluid descending through the direct-contact exchanger, exchanging heat, material, or heat and material with bubbles of a carrier gas. The carrier gas passes through the gas inlet, the carrier gas ascending upward through the ascending gas channels, exchanging heat with the fluid. The carrier gas bubbles into the direct-contact exchanger as the bubbles of the carrier gas with sufficient momentum to prevent the fluid from passing into the ascending gas channels. The fluid passes through the descending fluid channels and out of the fluid outlet.

In some embodiments, the carrier gas comprises flue gas, syngas, producer gas, natural gas, steam reforming gas, hydrocarbons, light gases, refinery off-gases, organic solvents, steam, ammonia, or combinations thereof. In some embodiments, the carrier gas further comprises entrained solids, the entrained solids comprising salts, biomass, dust, ash, or combinations thereof. In some embodiments, the carrier gas further comprises a vapor component. In some embodiments, the vapor component comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

In some embodiments, the fluid comprises water, hydrocarbons, liquid ammonia, liquid carbon dioxide, cryogenic liquids, or combinations thereof. In some embodiments, the fluid further comprises an entrained solid.

In some embodiments, the fluid extracts the vapor component by desublimation, condensation, freezing, entrainment, absorption, or combinations thereof. In some embodiments, the vapor component extracted into the fluid evaporates, sublimates, or combinations thereof, in the descending fluid channels, producing a product gas comprising the vapor component. In some embodiments, the product gas and the fluid are passed from the fluid outlet through a vapor-liquid separator, such that the product gas and the fluid are separated.

In some embodiments, flow of the fluid through a top portion of the ascending gas channels is further prevented by use of orifices, sieves, bubble caps, or combinations thereof.

In some embodiments, the top portion further comprises a second indirect-contact heat exchanger, the indirect-contact heat exchanger providing cooling to the fluid.

In some embodiments, the fluid inlet comprises spray nozzles, droplet generators, misters, or combinations thereof.

In some embodiments, the indirect-contact heat exchanger comprises plates, tubes, pipes, or combinations thereof.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A shows a cross-sectional side view of a combined direct-contact exchanger (DCE) and indirect-contact heat exchanger (ICHE) for removing a vapor component from a carrier gas.

FIG. 1B shows an isometric front-left view of the combined DCE and ICHE of FIG. 1A.

FIG. 1C shows an isometric front-left view of the ICHE of FIG. 1A.

FIG. 1D shows an isometric back-right view of the ICHE of FIG. 1A.

FIG. 2 shows a cross-sectional view of a combined DCE and ICHE for removing a vapor component from a carrier gas, with an additional ICHE in the DCE.

FIG. 3A a cross-sectional side view of a combined DCE and ICHE for removing a vapor component from a carrier gas.

FIG. 3B shows a top view of the ICHE of FIG. 3A.

FIG. 3C shows an isometric front-left view of the combined DCE and ICHE of FIG. 3A.

FIG. 4 shows a method for separating a vapor component from a gas by a combined DCE and ICHE.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

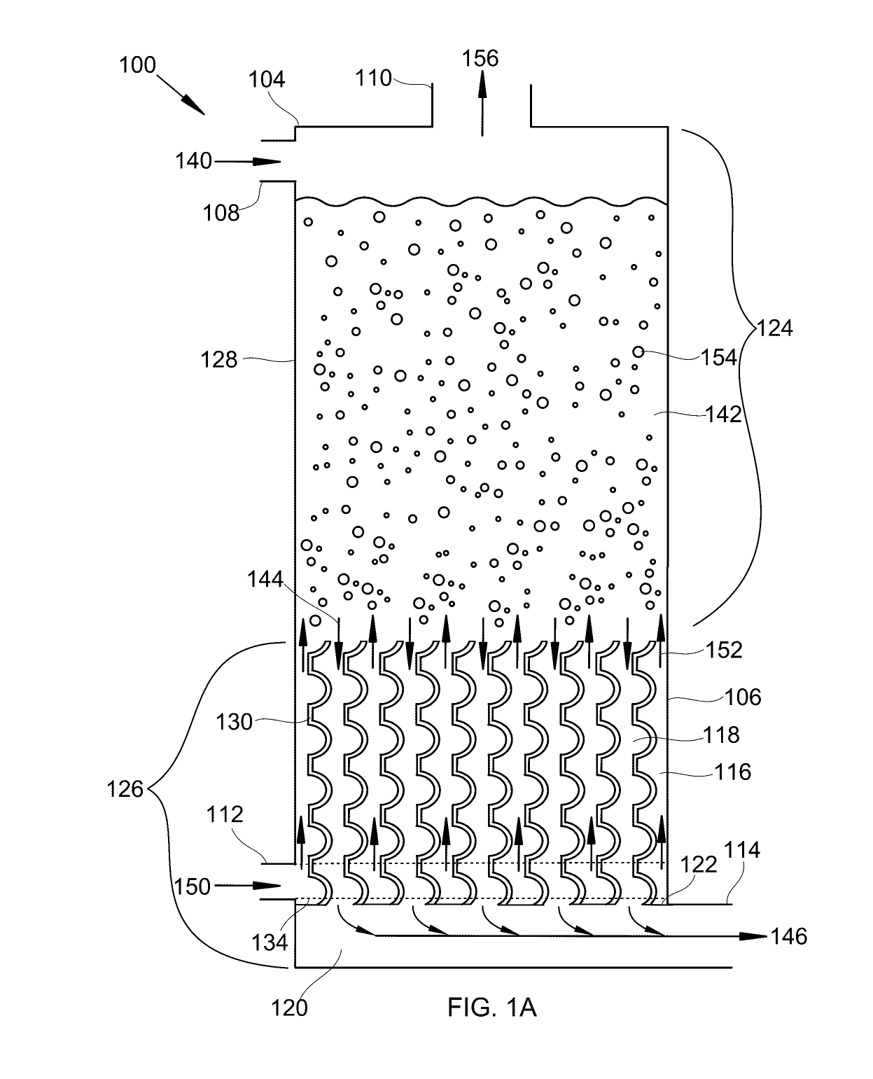

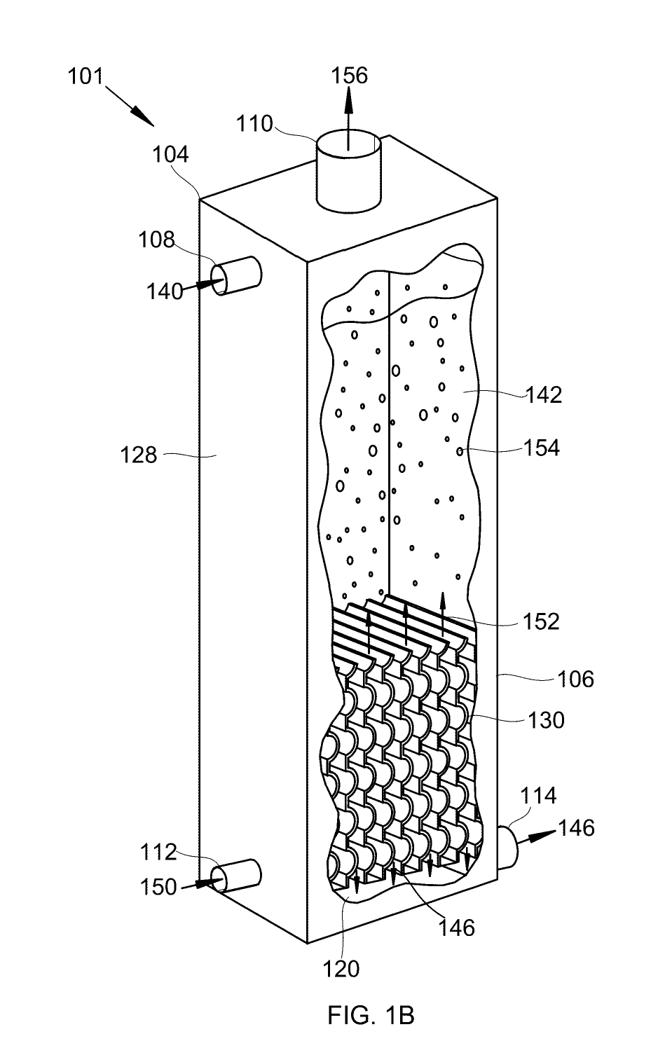

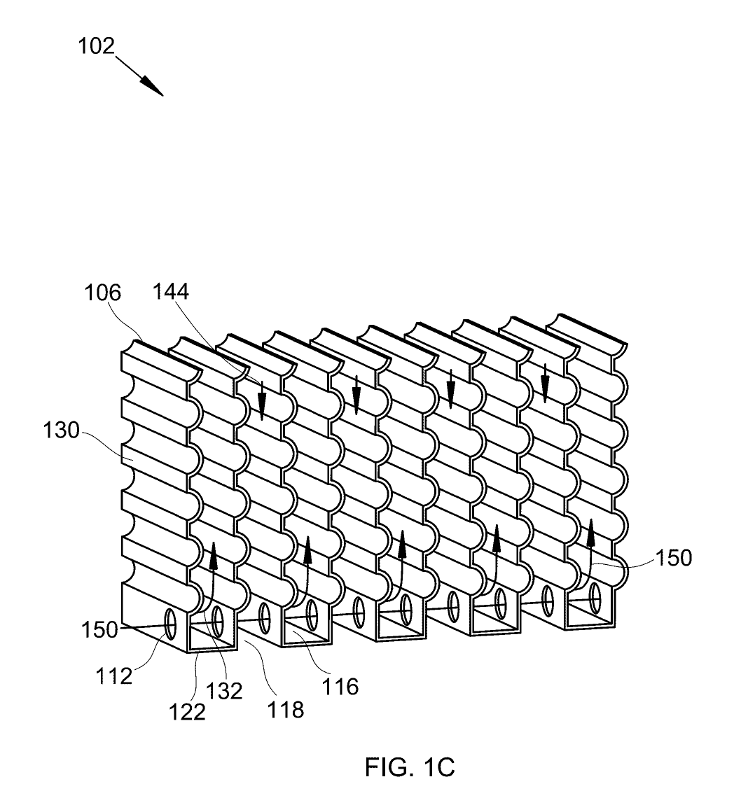

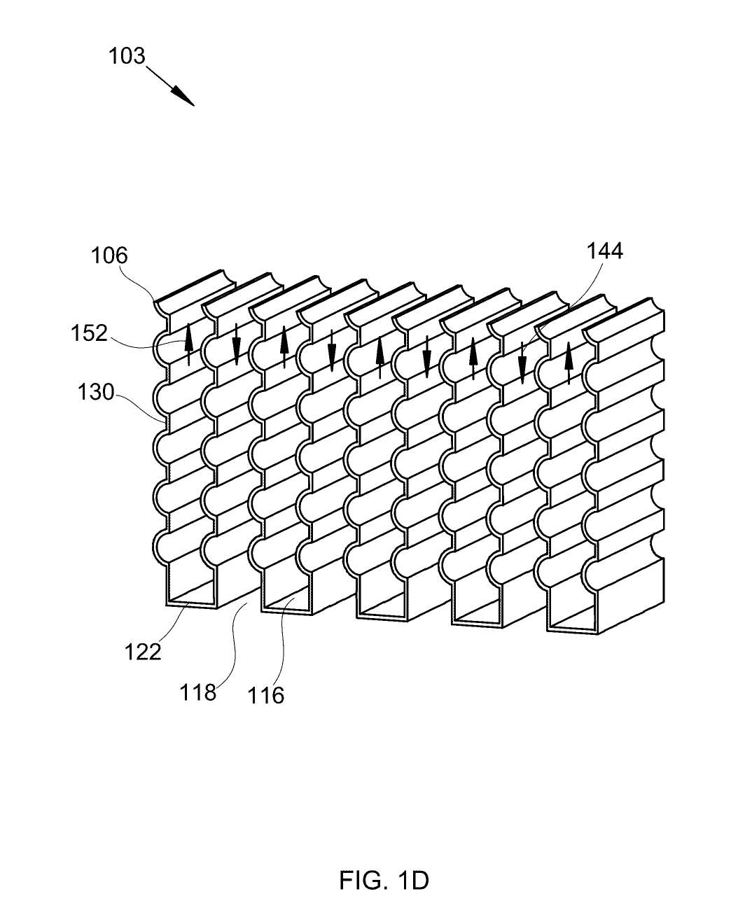

Referring to FIG. 1A, a cross-sectional side view of a combined direct-contact exchanger (DCE) and indirect-contact heat exchanger (ICHE) for removing a vapor component from a carrier gas is shown at 100, as per one embodiment of the present invention. Vessel 104 comprises top portion 124 and bottom portion 126. Top portion 124 comprises gas outlet 110, fluid inlet 108, and DCE 128. Bottom portion 126 comprises ICHE 106, gas inlet manifold 112, and fluid outlet manifold 114. ICHE 106 is aligned vertically and comprises parallel plates 130. Plenums between plates 130 comprise alternating, adjacent ascending gas channels 116 and descending fluid channels 118. The sizes of the ascending gas channels 116 and descending fluid channels 118 are exaggerated to render the drawings clear. Channel sizes need not be symmetric. Gas inlet manifold 112 comprises pipe 134 that crosses through all of plates 130, with holes 132 in pipe 134, in a bottom portion of each of ascending gas channels 116. The pipe is shown only as a dashed line in FIG. 1A, and is not shown in FIGS. 1B-D, for clarity. Holes 132 are shown in FIG. 1B, without the pipe shown. Fluid outlet manifold 120 comprises five outlets adjacent to a bottom portion of each of descending fluid channels 118.

Fluid 140 passes through fluid inlet 108 and descends through DCE 128, exchanging heat, material, or heat and material with bubbles 154 of carrier gas 152. Carrier gas 150 passes through gas inlet 112 and upward through ascending gas channels 116, exchanging heat with fluid 144. Carrier gas 152 bubbles into DCE 128 as bubbles 154 of carrier gas 152 with sufficient momentum to prevent fluid 144 from passing into ascending gas channels 116. Fluid 144 passes through descending fluid channels 118 and passes out of fluid outlet 114. Sufficient momentum can refer to high enough pressure in the fluid flow, high enough fluid flow, restrictions in the opening, or combinations thereof.

This combination of a DCE and an ICHE produces a unique blend of benefits for the overall system that are not present alone. First, carrier gas is pre-cooled by the warmed descending fluid. Then, the ICHE acts as a bubbler in the DCE. Warmed descending fluid is also warmed as it passes through the ICHE. In some embodiments, such as with acid gases being stripped from combustion flue gases, the acid gases are dissolved or entrained in the fluid as it enters the ICHE. Warming this mixture sufficiently will cause the acid gases to sublimate or vaporize out, resulting in a gas phase comprising substantially only acid gases, and a liquid phase with minimal acid gases still dissolved or entrained. Subsequent gas-liquid separations after leaving the ICHE are, therefore, extremely simple and produce highly purified acid gases. This is especially true of carbon dioxide.

Referring to FIG. 1B, an isometric front-left view of the combined DCE and ICHE of FIG. 1A is shown at 101.

Referring to FIG. 1C, an isometric front-left view of the ICHE of FIG. 1A is shown at 102.

Referring to FIG. 1D, an isometric back-right view of the ICHE of FIG. 1A is shown at 103.

In some embodiments, ascending gas channels are significantly larger than descending fluid channels.

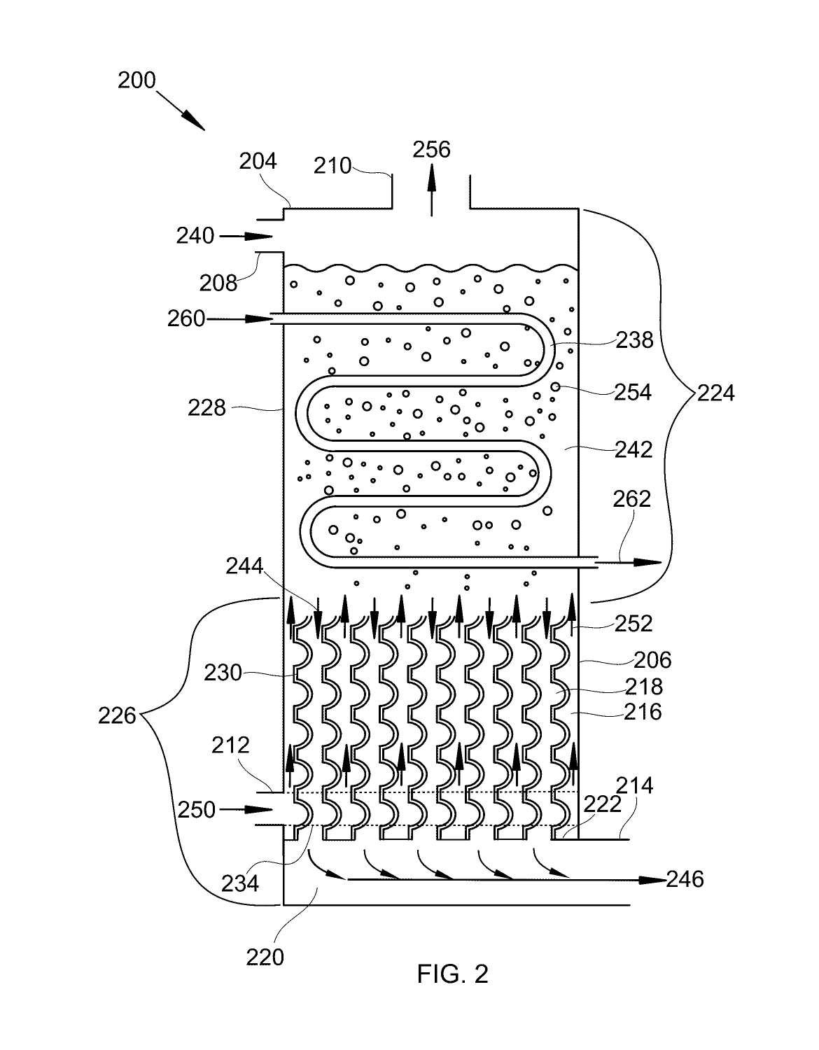

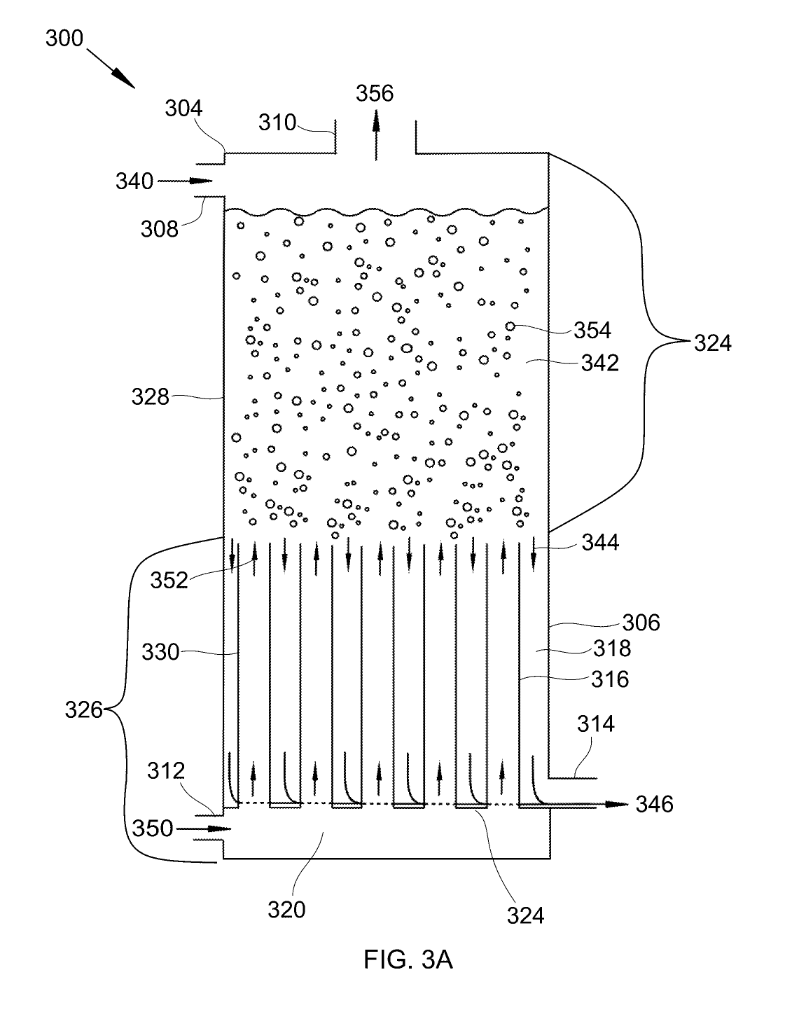

Referring to FIG. 2, a cross-sectional view of a combined DCE and ICHE for removing a vapor component from a carrier gas, with an additional ICHE in the DCE, is shown at 200, as per one embodiment of the present invention. Vessel 204 is substantially the same as Vessel 104, with the addition of the additional ICHE in the DCE. Vessel 204 comprises top portion 224 and bottom portion 226. Top portion 224 comprises gas outlet 210, fluid inlet 208, DCE 228, and second ICHE 238. Bottom portion 226 comprises ICHE 206, gas inlet manifold 212, and fluid outlet manifold 214. ICHE 206 is aligned vertically and comprises parallel plates 230. Plenums, or the spaces between plates 230 comprise alternating, adjacent ascending gas channels 216 and descending fluid channels 218. Plates 230 are similar to the plates 130 discussed with respect to FIGS. 1A-D. The sizes of the ascending gas channels 216 and descending fluid channels 218 are exaggerated to render the drawings clear. Channel sizes need not be symmetric. Gas inlet manifold 212 comprises pipe 234 that crosses through all of plates 230, with holes in pipe 234, in a bottom portion of each of ascending gas channels 216. The pipe is shown only as a dashed line. Fluid outlet manifold 220 comprises five outlets adjacent to a bottom portion of each of descending fluid channels 218.

Fluid 240 passes through fluid inlet 208 and descends through DCE 228, exchanging heat, material, or heat and material with bubbles 254 of carrier gas 252. Fluid 240 exchanges heat with coolant 260 through second ICHE 238. Carrier gas 250 passes through gas inlet 212 and upward through ascending gas channels 216, exchanging heat with fluid 244. Carrier gas 252 bubbles into DCE 228 as bubbles 254 of carrier gas 252 with sufficient momentum to prevent fluid 244 from passing into ascending gas channels 216. Fluid 244 passes through descending fluid channels 218 and passes out of fluid outlet 214.

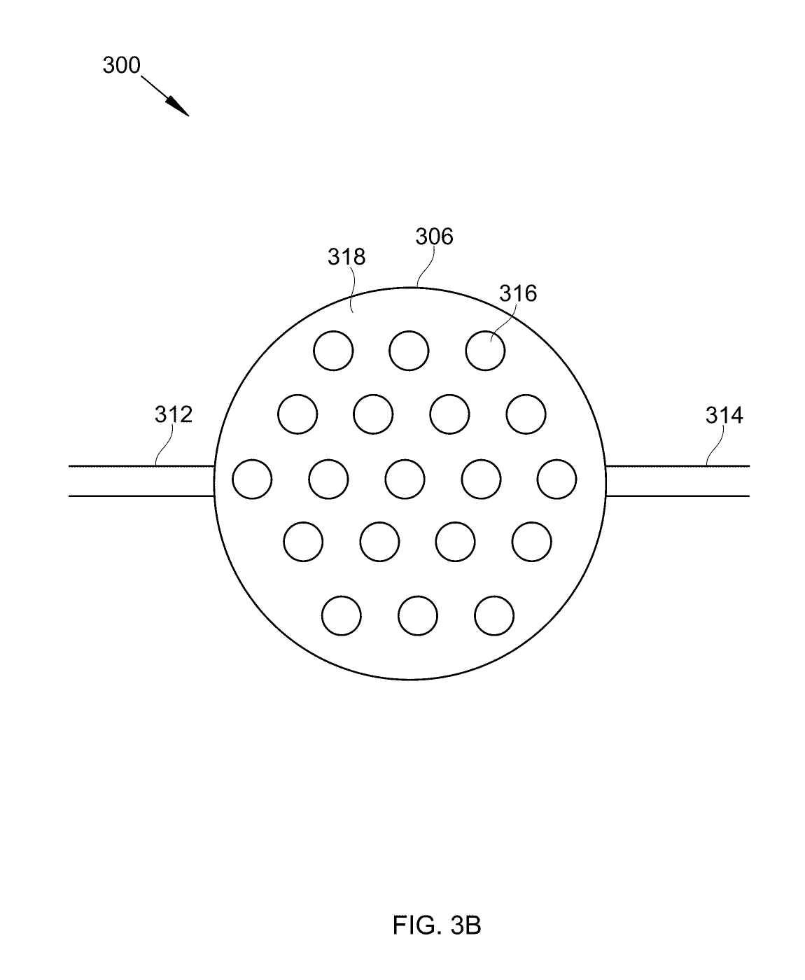

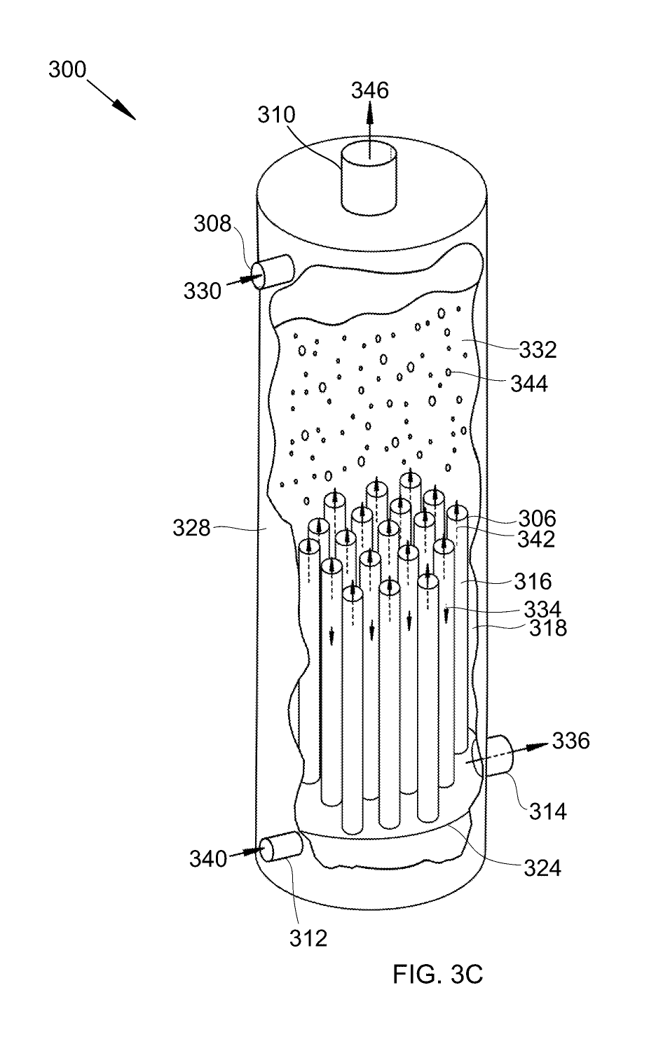

Referring to FIG. 3A, a cross-sectional side view of a combined DCE and ICHE for removing a vapor component from a carrier gas is shown at 300, as per one embodiment of the present invention. Vessel 304 comprises top portion 324 and bottom portion 326. Top portion 324 comprises gas outlet 310, fluid inlet 308, and DCE 328. Bottom portion 326 comprises ICHE 306, gas inlet manifold 312, and fluid outlet manifold 314. ICHE 306 is aligned vertically and comprises parallel tubes 330. Plenums inside tubes 330 comprise ascending gas channels 316 and descending fluid channels 318. The sizes of the ascending gas channels 316 and descending fluid channels 318 are exaggerated to render the drawings clear. Channel sizes need not be symmetric, e.g., all channels may be symmetric, may be asymmetric, or only a portion may be symmetric. Gas inlet manifold 312 comprises pipe 334 that crosses through all of plates 330, with holes 332 in pipe 334, in a bottom portion of each of ascending gas channels 316. The pipe is shown only as a dashed line in FIG. 3A, and is not shown in FIGS. 3B-D, for clarity. Holes 332 is shown in FIG. 3B, without the pipe shown. Fluid outlet manifold 320 comprises five outlets adjacent to a bottom portion of each of descending fluid channels 318.

Fluid 340 passes through fluid inlet 308 and descends through DCE 328, exchanging heat, material, or heat and material with bubbles 354 of carrier gas 352. Carrier gas 350 passes through gas inlet 312 and upward through ascending gas channels 316, exchanging heat with fluid 344. Carrier gas 352 bubbles into DCE 328 as bubbles 354 of carrier gas 352 with sufficient momentum to prevent fluid 344 from passing into ascending gas channels 316. Fluid 344 passes through descending fluid channels 318 and passes out of fluid outlet 314.

Referring to FIG. 3B, a top view of the ICHE of FIG. 3A is shown at 301.

Referring to FIG. 3C, an isometric front-left view of the combined DCE and ICHE of FIG. 3A is shown at 302.

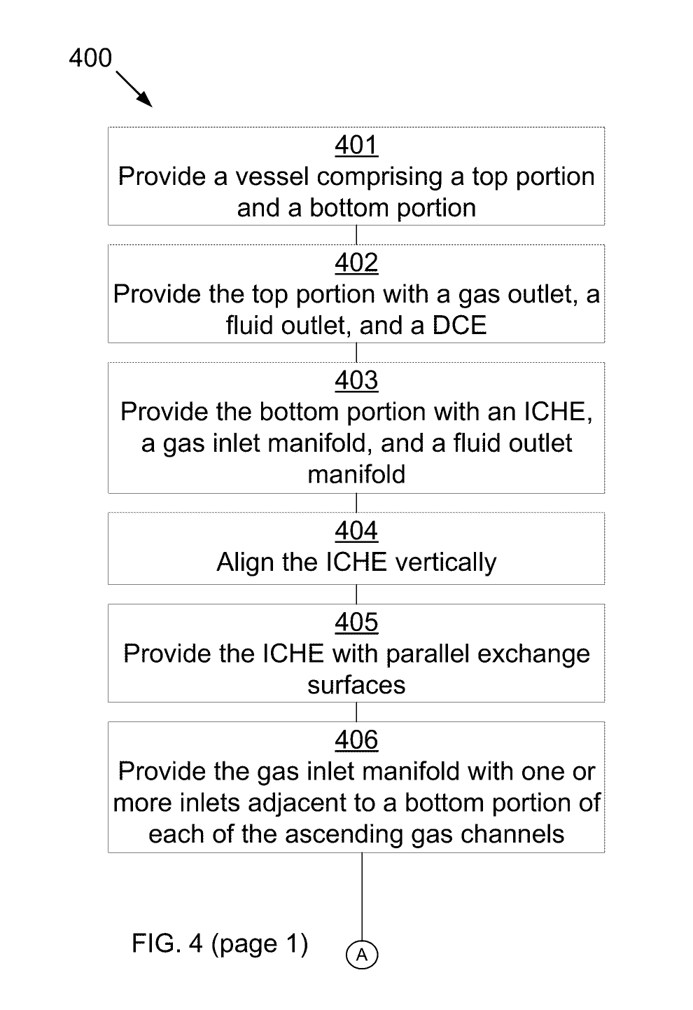

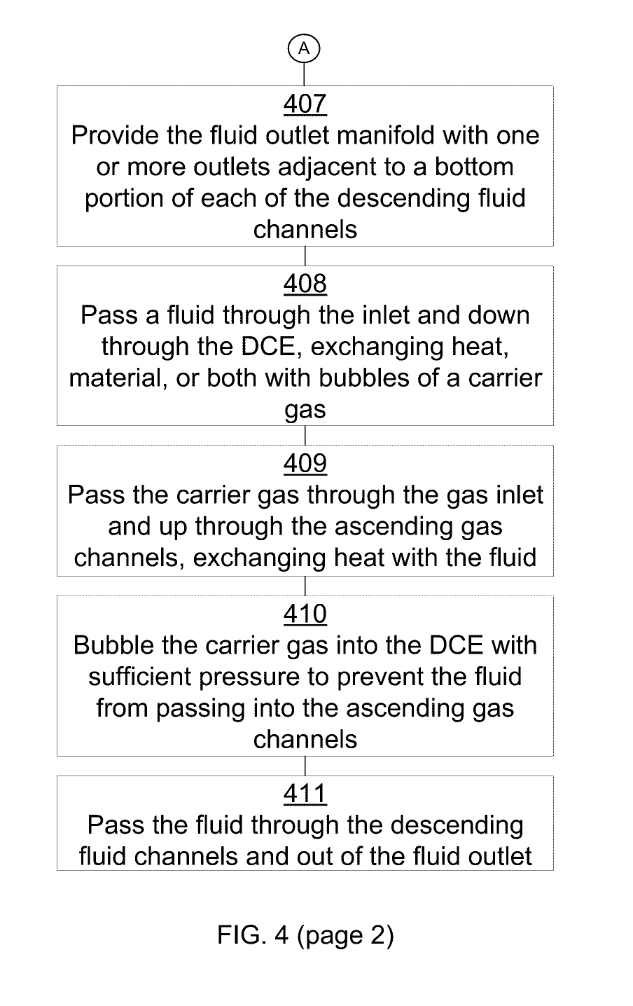

Referring to FIG. 4, a method for separating a vapor component from a carrier gas by a combined DCE and ICHE is shown at 400, as per one embodiment of the present invention. A vessel comprising a top portion and a bottom portion is provided 401. The top portion is provided with a gas outlet, a fluid inlet, and a DCE 402. The bottom portion is provided with an ICHE, a gas inlet manifold, and a fluid outlet manifold 403. The ICHE is aligned vertically 404 and is provided with parallel exchange surfaces 405. Plenums between the exchange surfaces comprise alternating, adjacent ascending gas channels and descending fluid channels. The gas inlet manifold is provided with one or more inlets adjacent to a bottom portion of each of the ascending gas channels 406. The fluid outlet manifold is provided with one or more outlets adjacent to a bottom portion of each of the descending fluid channels 407. A fluid is passed through the fluid inlet and descends through the DCE, exchanging heat, material, or heat and material with bubbles of a carrier gas 408. The carrier gas passes through the gas inlet and ascends upward through the ascending gas channels, exchanging heat with the fluid 409. The carrier gas bubbles into the DCE as the bubbles of the carrier gas with sufficient momentum to prevent the fluid from passing into the ascending gas channels 410. The fluid passes through the descending fluid channels and out of the fluid outlet 411. In some embodiments, method 400 may be implemented using any of the combined exchangers illustrated in FIGS. 1-3.

In some embodiments, the carrier gas comprises flue gas, syngas, producer gas, natural gas, steam reforming gas, hydrocarbons, light gases, refinery off-gases, organic solvents, steam, ammonia, or combinations thereof. In some embodiments, the carrier gas further comprises entrained solids, the entrained solids comprising salts, biomass, dust, ash, or combinations thereof. In some embodiments, the carrier gas comprises a vapor component. In some embodiments, the vapor component comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

In some embodiments, the fluid comprises water, hydrocarbons, liquid ammonia, liquid carbon dioxide, cryogenic liquids, or combinations thereof. In some embodiments, the fluid comprises an entrained solid.

In some embodiments, the fluid extracts the vapor component by desublimation, condensation, freezing, entrainment, absorption, or combinations thereof.

In some embodiments, the vapor component extracted into the fluid evaporates, sublimates, or combinations thereof, in the descending fluid channels, producing a product gas comprising the vapor component. For eutectic mixtures, this occurs when the fluid is at a temperature below the eutectic curve of the mixture and is brought to the temperature of that curve. At that point, the vapor component begins to come out of the fluid, resulting in a pure or nearly pure gas consisting only or primarily of the vapor component.

In some embodiments, the product gas and the fluid are passed from the fluid outlet through a vapor-liquid separator, such that the product gas and the fluid are separated.

In some embodiments, flow of the fluid through a top portion of the ascending gas channels is further prevented by use of orifices, sieves, bubble caps, or combinations thereof.

In some embodiments, the top portion further comprises a second indirect-contact heat exchanger, the indirect-contact heat exchanger providing cooling to the fluid.

In some embodiments, the fluid inlet comprises spray nozzles, droplet generators, misters, or combinations thereof.

In some embodiments, the indirect-contact heat exchanger comprises plates, tubes, pipes, or combinations thereof.

Combustion flue gas consists of the exhaust gas from a fireplace, oven, furnace, boiler, steam generator, or other combustor. The combustion fuel sources include coal, hydrocarbons, and biomass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entrained dust and soot will also be present in all combustion flue gas streams. The method disclosed applies to any combustion flue gases. Dried combustion flue gas has had the water removed.

Syngas consists of hydrogen, carbon monoxide, and carbon dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

We claim:

1. A device for separating a vapor component from a gas comprising:
a vessel comprising a top portion and a bottom portion, the top portion comprising a gas outlet, a fluid inlet, and a direct-contact heat exchanger, and the bottom portion comprising an indirect-contact heat exchanger, a gas inlet manifold, and a fluid outlet manifold;
the indirect-contact heat exchanger aligned vertically within the vessel and comprising parallel heat exchange surfaces, wherein plenums between the heat exchange surfaces comprise alternating, adjacent ascending gas channels and descending fluid channels; and,
the gas inlet manifold comprising one or more inlets adjacent to a bottom portion of each of the ascending gas channels, and the fluid outlet manifold comprising one or more outlets adjacent to a bottom portion of each of the descending fluid channels.

2. The device of claim 1, wherein:
a fluid passes through the fluid inlet and descends through the direct-contact exchanger, exchanging heat, material, or heat and material with bubbles of a carrier gas;
the carrier gas passes through the gas inlet and upward through the ascending gas channels, exchanging heat with the fluid;
the carrier gas bubbles into the direct-contact exchanger as the bubbles of the carrier gas with sufficient momentum to prevent the fluid from passing into the ascending gas channels;
the fluid passes through the descending fluid channels and passes out of the fluid outlet.

3. The device of claim 2, wherein the carrier gas comprises flue gas, syngas, producer gas, natural gas, steam reforming gas, hydrocarbons, light gases, refinery off-gases, organic solvents, steam, ammonia, or combinations thereof.

4. The device of claim 3, wherein the carrier gas comprises a vapor component comprising carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

5. The device of claim 4, wherein the fluid comprises water, hydrocarbons, liquid ammonia, liquid carbon dioxide, cryogenic liquids, or combinations thereof.

6. The device of claim 5, wherein the fluid extracts the vapor component by desublimation, condensation, freezing, entrainment, absorption, or combinations thereof.

7. The device of claim 6, wherein the vapor component extracted into the fluid evaporates, sublimates, or combinations thereof, in the descending fluid channels, producing a product gas comprising the vapor component.

8. The device of claim 2, wherein flow of the fluid through a top portion of the ascending gas channels is further prevented by use of orifices, sieves, bubble caps, or combinations thereof.

9. The device of claim 2, wherein the top portion further comprises a second indirect-contact heat exchanger, the indirect-contact heat exchanger providing cooling to the fluid.

10. The device of claim 2, wherein the fluid inlet comprises spray nozzles, droplet generators, misters, or combinations thereof.

11. The device of claim 2, wherein the indirect-contact heat exchanger comprises plates, tubes, pipes, or combinations thereof.

12. A method for separating a vapor component from a gas comprising:
providing a vessel comprising a top portion and a bottom portion, the top portion comprising a gas outlet, a fluid inlet, and a direct-contact heat exchanger, and the bottom portion comprising an indirect-contact heat exchanger, a gas inlet manifold, and a fluid outlet manifold;
providing the indirect-contact heat exchanger aligned vertically and comprising parallel exchange surfaces, wherein plenums between the exchange surfaces comprise alternating, adjacent ascending gas channels and descending fluid channels;
providing the gas inlet manifold comprising one or more inlets adjacent to a bottom portion of each of the ascending gas channels, and the fluid outlet manifold comprising one or more outlets adjacent to a bottom portion of each of the descending fluid channels;
passing a fluid through the fluid inlet, the fluid descending through the direct-contact exchanger, exchanging heat, material, or heat and material with bubbles of a carrier gas;
passing the carrier gas through the gas inlet, the carrier gas ascending upward through the ascending gas channels, exchanging heat with the fluid;
bubbling the carrier gas into the direct-contact exchanger as the bubbles of the carrier gas with sufficient momentum to prevent the fluid from passing into the ascending gas channels;
passing the fluid through the descending fluid channels and out of the fluid outlet.

13. The method of claim 12, providing the carrier gas comprising flue gas, syngas, producer gas, natural gas, steam reforming gas, hydrocarbons, light gases, refinery off-gases, organic solvents, steam, ammonia, or combinations thereof, the carrier gas further comprising a vapor component, the vapor component comprising carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

14. The method of claim 13, providing the fluid comprising water, hydrocarbons, liquid ammonia, liquid carbon dioxide, cryogenic liquids, or combinations thereof.

15. The method of claim 14, wherein the fluid extracts the vapor component by desublimation, condensation, freezing, entrainment, absorption, or combinations thereof.

16. The method of claim 15, wherein the vapor component extracted into the fluid evaporates, sublimates, or combinations thereof, in the descending fluid channels, producing a product gas comprising the vapor component.

17. The method of claim 12, wherein flow of the fluid through a top portion of the ascending gas channels is further prevented by use of orifices, sieves, bubble caps, or combinations thereof.

18. The method of claim 12, wherein the top portion further comprises a second indirect-contact heat exchanger, the indirect-contact heat exchanger providing cooling to the fluid.

19. The method of claim 12, providing the fluid inlet comprising spray nozzles, droplet generators, misters, or combinations thereof.

20. The method of claim 12, providing the indirect-contact heat exchanger comprising plates, tubes, pipes, or combinations thereof.
